(19) United States
(12) Patent Application Publication
(10) Pub. No.: US 2003/0018554 A1
(43) Pub. Date: Jan. 23, 2003

(54) Network and process for settling financial transactions

(75) Inventors: Rick B. Lyftogt, Paradise Valley, AZ (US); Kerry S. Jones, Phoenix, AZ (US)

Correspondence Address: Michael Best & Friedrich LLP, 100 East Wisconsin Avenue, Milwaukee, WI, 53202-4108, US

(73) Assignee: eFunds Corporation, Milwaukee, WI

(21) Appl. No.: 10/165,321

(22) Filed: Jun. 7, 2002

Related U.S. Application Data
(60) Provisional application No. 60/296,710, filed on Jun. 7, 2001.

(51) Int. Cl. G06F 17/60

(52) U.S. Cl. 705/35

(57) ABSTRACT

The invention provides a network and process for simplifying the processing and settlement of financial transactions between financial institutions that are members of different automated clearing house networks.

### RELATED APPLICATIONS

This application claims the benefit of prior filed co-pending provisional patent application number 60/296,710 filed on Jun. 7, 2001.

### BACKGROUND OF THE INVENTION

The invention relates to a network and process for settling financial transactions, and more particularly to a network and process for simplifying the settlement of electronic financial transactions as between automated clearing house operators.

Presently, when an automated clearing house (“ACH”) transaction (hereinafter “transaction”) occurs, the originating financial institution creates a transaction data file to effect the processing and settlement of the transaction through an ACH operator and the ACH network. The purpose of the ACH is to efficiently process and settle transactions between and among financial institutions. The terms “processing” and “settlement” have various definitions within the industry. As used herein, the term “processing” means the sorting of the financial transaction data files by financial institutions, and the term “settling” means the transfer of money or reconciling of accounts between financial institutions. Transactions are electronically processed and settled between financial institutions through a group of automated clearing house operators (hereinafter “operators”) such as the American Clearing House Association (ACHA), VISA, the Federal Reserve, and the Electronic Payment Network (EPN). ACHA, VISA, and EPN together comprise the Private ACH Exchange (PAX). After a transaction is processed and settled by an operator, a settlement report is generated and sent to the financial institution to allow the financial institution to reconcile its accounts.

Under the current system for processing and settling transactions, a financial institution must join multiple ACH networks in order to settle any transactions that occur within other operator networks. Under the current system as shown in FIG. 1, each operator separates the transactions into separate settlement files for each of its member financial institutions. For transactions involving non-member financial institutions, the operator passes the transaction file to the operator network that the non-member financial institution belongs to for that operator to process and effectuate settlement. Thus, each operator only calculates and creates settlement files for its member financial institutions. Ultimately, a settlement report is electronically sent back to each financial institution involved in the transaction by each operator. In order for a financial institution to settle its books, the financial institution must reconcile the settlement reports from each of the different operators. This process can be very time consuming, complex and expensive.

### SUMMARY OF THE INVENTION

Thus, there is a need to provide a network and process for simplifying the settlement of financial transactions between financial institutions that are members of different ACH networks. Accordingly, the invention provides an improved settlement network and process that includes the use of an inter-operator settlement account to allow each operator to settle the transactions for each of their member financial institutions, and to allow operators to send transaction entries directly to each of the other operators. For example, as shown in FIG. 2, one operator, e.g. ACHA, performs settlement for all of the financial institutions in the ACHA network, the PAX network, and the Federal Reserve network. While settlement accounts have previously been used to settle financial accounts directly between individual financial institutions, they have to our knowledge never been used to simplify account reconciling between operators.

It is an advantage to provide a settlement network and process that simplifies the processing and settling of transactions directly between operators, and specifically between financial institutions belonging to different ACH networks.

It is another advantage of the invention to provide a settlement network and process that utilizes an inter-operator settlement account to reconcile financial transactions between financial institutions belonging to different ACH networks.

It is still another advantage of the invention to provide a settlement network and process that generates only a single net settlement entry reflecting the net settlement as between all operators for each financial institution.

It is still another advantage of the invention that financial institutions will not need to join multiple ACH networks to facilitate the processing and settling of ACH transactions.

Other features and advantages of the invention are set forth in the attached drawings, description and claims.

### BRIEF DESCRIPTION OF THE DRAWINGS

FIG. 1 illustrates a settlement network and process of the prior art.

FIG. 2 illustrates a settlement network and process embodying the invention.

FIG. 3. illustrates settlement accounts for the settlement network of FIG. 2.

FIG. 4 illustrates an example of the prior art settlement process of FIG. 1.

FIG. 5 illustrates an example of the settlement process of FIG. 2 embodying the present invention.

Before one embodiment of the invention is explained in full detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including” and “comprising” and variations thereof herein is meant to encompass the items listed thereafter and equivalents thereof as well as additional items.

### DETAILED DESCRIPTION OF THE PREFERRED EMBODIMENT

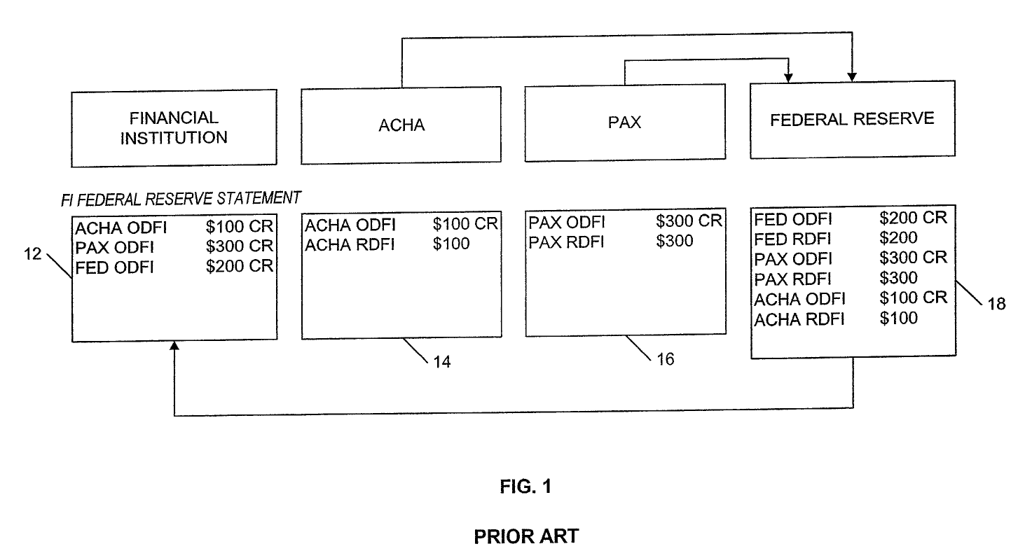

FIG. 1 illustrates the settlement process of the prior art, which is currently used by financial institutions, operators such as ACHA and PAX, and the Federal Reserve. FIG. 1 also illustrates four separate account statements: a financial institution Federal Reserve statement 12, an ACHA statement 14, a PAX statement 16, and a Federal Reserve statement 18. The account statements in FIG. 1 illustrate three separate transactions between an originating depository financial institution (ODFI) and multiple receiving depository financial institutions (RDFI). In the three transactions, $100, $200, and $300 is being transferred between the ODFI and the RDFI. As shown in the ACHA statement 14, a transaction of $100 has occurred between the ODFI and the RDFI. In this example, both the ODFI and the RDFI are members of the ACHA network. The ODFI is assigned a credit entry of $100 and the RDFI is assigned a debit entry $100. As shown in the PAX statement 16, a transaction of $300 has occurred between the ODFI and the RDFI. Here, both the ODFI and the RDFI are members of the PAX network. The ODFI is assigned a credit entry of $300 and the RDFI is assigned debit entry of $300. As shown in the Federal Reserve Statement 18, a transaction of $200 has occurred between the ODFI and the RDFI. Here, rather than using a private ACH, such as ACHA or PAX, the ODFI and the RDFI both settle their accounts directly with the Federal Reserve. The ODFI is assigned a credit entry of $200 and the RDFI is assigned a debit entry of $200.

The credit and debit entries for the ODFI and the RDFI are then entered into the Federal Reserve statement 18. The $200 transaction that occurred between the ODFI and the RDFI settling their accounts directly with the Federal Reserve is entered in the Federal Reserve statement 18. The $100 transaction that occurred in the ACHA network is entered in the Federal Reserve statement 18, and the $300 transaction that occurred in the PAX network is entered in the Federal Reserve statement 18. In this manner, the books of the Federal Reserve are debited and credited for each financial institution involved in the transaction.

Based on the Federal Reserve statement 18, the financial institution Federal Reserve statement 12 is then generated for the ODFI. Similarly, a second financial institution Federal Reserve statement (not shown) is also generated for the RDFI. The financial institution Federal Reserve statement 12 includes the ACHA ODFI $100 credit entry, the PAX ODFI $300 credit entry, and the Federal Reserve ODFI $200 credit entry.

The financial institution Federal Reserve statement for the RDFIs would include the ACHA ODFI $100 debit entry, the PAX ODFI $300 debit entry, and the Federal Reserve ODFI $200 debit entry. Once the financial institution receives the statement 12, the financial institution must reconcile its accounts with each of the three credit entries.

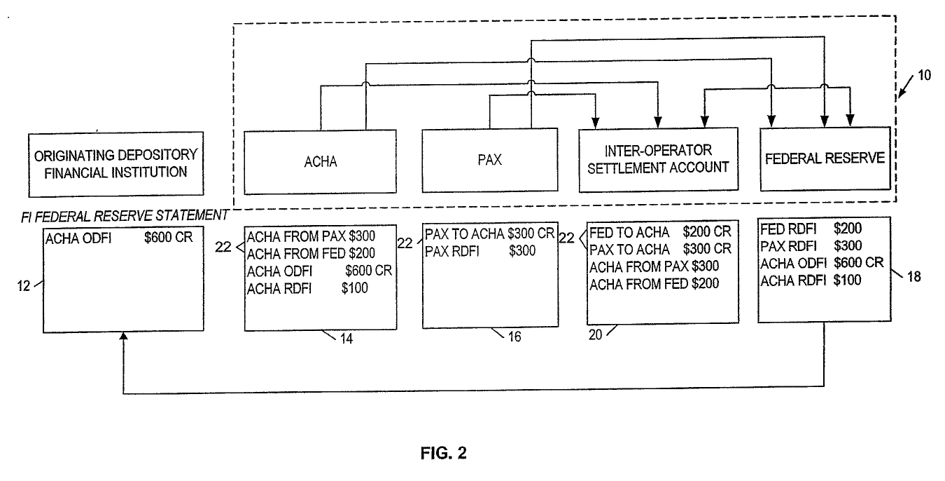

FIG. 2 illustrates a settlement network 10 embodying the present invention. In addition to the four statements shown in FIG. 1, FIG. 2 illustrates a fifth inter-operator settlement account statement 20. The inter-operator settlement account may also be referred to as an in-process account or a clearing account. FIG. 2 illustrates three transactions that occurred between an ODFI within one ACH network and an RDFI within another ACH network. Specifically, FIG. 2 illustrates a $100 transaction destined to an RDFI that is a member of the ACHA network, a $200 transaction destined to an RDFI that is a member of the Federal Reserve network, and a $300 transaction destined to an RDFI that is a member of the PAX network.

Rather than each of the operators only calculating the settlements for the transactions that are both originated and received in member financial institutions within their own network, the operators calculate the settlements for all of the transactions that are originated or received by their member financial institutions. Referring to FIG. 2, once the operators have calculated the settlements for all of three of the transactions, the operators calculate a plurality of settlement offsets 22 that are sent to the Inter-Operator Settlement Account statement 20,. The entries in the inter-operator settlement account statement 20 are then reconciled in order to ensure that the entries net to zero. Once the entries in the inter-operator settlement account statement 20 are reconciled, the resulting ODFI and RDFI settlement entries are forwarded to the Federal Register statement 18 for posting on the financial institution accounts.

Based on the Federal Reserve statement 18, the financial institution Federal Reserve statement 12 is then generated for the ODFI. Similarly, financial institution Federal Reserve statements (not shown) are also generated for the RDFIs. Rather than including several separate entries, the ODFI financial institution Federal Reserve statement 12 only includes a single daily balance entry, e.g. a credit entry of ACHA ODFI $600. The financial institution Federal Reserve statements for the RDFIs would also include only a single daily balance entry. Thus, rather than having to reconcile its accounts with three separate entries, the financial institution must only reconcile its accounts with one entry.

To summarize, in the settlement network 10 embodying the present invention, each operator can exchange transactions directly with each of the other operators. Rather than calculating and processing the settlement entries only for those transactions drawn on the operator's member financial institutions, each operator calculates and processes the settlement entries for all of the transactions received or sent by their member financial institutions. The operators use the inter-operator settlement account 20 to settle all inter-operator transactions, even if the transaction occurs with a financial institution within another operator network. After all of the operators have submitted settlement entries to the inter-operator settlement account 20, the balance in the inter-operator settlement account 20 is net-zero, i.e. the debits equal the credits. The settlement of all of the transactions for the day is not complete until all the operators have submitted settlement entries. The inter-operator settlement account 20 can be maintained by any one of the private operators or by the Federal Reserve.

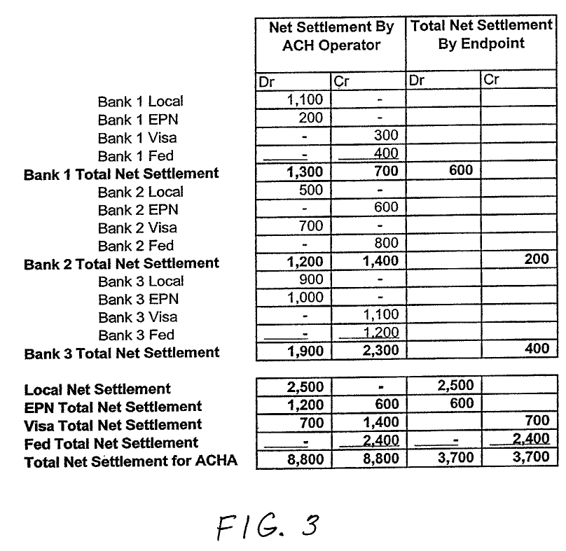

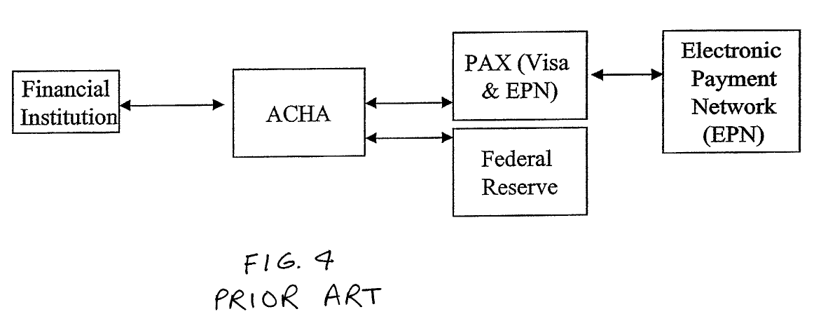

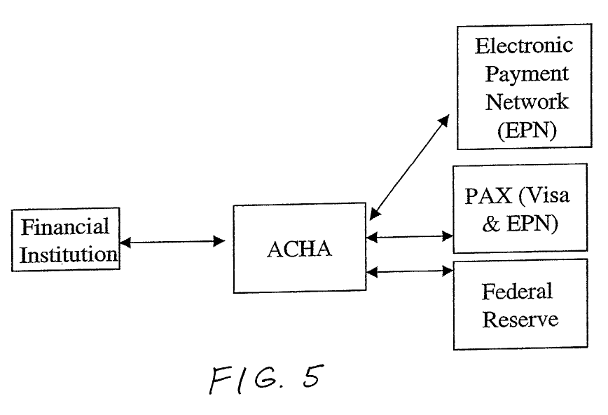

FIG. 3 illustrates an example of inter-operator settlement accounts for the settlement network of FIG. 2. FIG. 4 illustrates an example of the prior art settlement process between financial institutions, ACHA, PAX, EPN, and the Federal Reserve. FIG. 5 illustrates an example of the settlement process between financial institutions, ACHA, PAX, EPN, and the Federal Reserve embodying the present invention.

Various features and advantages of the invention are set forth in the following claims.

What is claimed is:

1. A network for settling and simplifying reconciliation of financial transactions between financial institutions belonging to different automated clearing house networks, the network comprising:
a plurality of automated clearing house networks each including a plurality of member financial institutions connected thereto; and
a settlement account resident at one of the automated clearing house networks for settling financial transactions between financial institutions of different automated clearing house networks so that only a single settlement report is sent to each financial institution.

2. A method of settling and reconciling financial transactions between financial institutions that are members of different automated clearing house networks, the method comprising:
providing a plurality of automated clearing house networks, each automated clearing house network having a plurality of member financial institutions;
providing a settlement account at one of the automated clearing house networks;
settling financial transactions between financial institutions of different automated clearing house networks using the settlement account; and
generating a single net settlement report for each financial institution.
